(19) United States
(12) Patent Application Publication
(10) Pub. No.: US 2023/0129507 A1
(43) Pub. Date: Apr. 27, 2023

(54) FROTH FLOTATION PROCESS AND FROTH STABILITY

(71) Applicant: THE UNIVERSITY OF QUEENSLAND, St. Lucia, Queensland (AU)

(72) Inventors: Liguang WANG, St Lucia, Queensland (AU); Chun Yong NG, St Lucia, Queensland (AU)

(21) Appl. No.: 17/622,051

(22) PCT Filed: Jun. 24, 2020
(86) PCT No.: PCT/AU2020/050635

§ 371 Date: Dec. 22, 2021

(30) Foreign Application Priority Data
Jun. 28, 2019 (AU) 2019902285

(51) Int. Cl. B03D 1/02; B03D 1/14; B03B 9/00

(52) U.S. Cl. CPC B03D 1/028; B03D 1/1462; B03B 9/00

(57) ABSTRACT

A method for stabilising a froth or a foam comprising subjecting the froth or foam to vibrations or sound waves having a frequency of less than 20 kHz. The frequency may be less than 1 kHz, for example, a frequency of from 300 Hz to 500 Hz, or from 300 to 450 Hz, or from 300 to 400 Hz. A method for froth flotation is also described.

### CROSS-REFERENCE TO RELATED APPLICATIONS

This application is the U.S. national phase of International Application No. PCT/AU2020/050635 filed Jun. 24, 2020, which designated the U.S. and claims priority to AU Patent Application No. 2019902285 filed Jun. 28, 2019, the entire contents of each of which are hereby incorporated by reference.

### TECHNICAL FIELD

The present invention relates to a process for improving or stabilizing a froth. The process is suitable for use in an improved froth flotation process.

### BACKGROUND ART

Froths and foams are present in many industrial processes. A foam is typically a collection of gas bubbles encased in liquid films. A froth is similar but the liquid may also include entrained particles. Throughout this specification, the term “foam” will be used to refer to a collection of gas bubbles encased in a liquid film and the term “froth” will be used to refer to a collection of gas bubbles encased in a liquid film and also containing particles or particulate matter. Within the scope of these broad descriptions, it will be understood that the person skilled in the art will appreciate that a foam layer consists of three elements: gas bubble, thin film and interconnecting plateau borders. A froth additionally includes particulate material.

In many industrial processes, the presence of a froth or a foam can be detrimental to the process. For example, froths and foams may make pumping difficult or they may make control of reaction vessels difficult. For example, foams can be generated in slags in metallurgical furnaces and this can lead to great difficulties in controlling those furnaces. For this reason, there has been much effort put into attempts to destabilise or break froths and foams in many processes.

However, there are also some industrial processes where the presence of a stable froth or foam is of benefit. For example, froth flotation is a mineral beneficiation process in which a slurry containing fine particulate mineral matter is mixed with a frother and a collector. Bubbles are formed and valuable mineral particles will typically stick to the bubbles and float to the surface whilst gangue particles of low value will sink. The froth that collects at the top of the froth flotation vessel either overflows the vessel or is skimmed from the top of the vessel and the beneficiated mineral concentrate can be collected from the froth for further processing. Froth flotation processes normally take place in a mechanical flotation cell in which an impeller breaks up injected gas bubbles, in a flotation column in which bubbles are injected into the liquid phase or in Jameson cells, where gas is injected into the liquid in a downcomer and the bubbles thus formed move into a separation vessel.

Froth flotation is a physiochemical separation process utilizing air bubbles to selectively pick up certain minerals and transport the aggregate to the upper froth zone while leaving other minerals behind in the lower pulp phase. The process efficiency is determined by many factors, including chemical reagents (e.g., collectors, frothers and modifiers) and hydrodynamic conditions (e.g., air flow rate and machine type and size).

Among the important operating variables of controlling flotation performance is the concentration of frother. Use of frothers at appropriate concentration levels can produce desirable bubble size, and stability and mobility of the froth phase, which in turn significantly affect the kinetic viability of the flotation process and its separation efficiency. Excessive frother addition may improve flotation recovery but could cause lower product grade and result in overfrothing problems in pumps, sumps, and thickeners. Reagent costs also increase if additional frother is used. On the other hand, insufficient frother addition in the flotation process often leads to loss of recovery of valuables.

Froth stability can also be slightly increased by increasing the aeration rate. In flotation practice, however, the aeration rate has an upper limit and in some flotation plants aeration rates are not available for automatic control because many conventional cells are self-aspirating.

The goal of a flotation process is to maximise recovery of valuables while meeting the requirement of product grade and fast breakdown of the froth discharged from flotation cells. In flotation, froth stability plays an important role in determining the kinetic viability of the flotation process and its separation efficiency. It is widely recognized that an increase in froth stability would lead to improved flotation recovery, and this is often achieved by adding more frothing agent (frother). However, this approach would increase operation cost and cause downstream problems (e.g., overly stable froth results in poor handleability in pump boxes, sumps, and dewatering devices). In coal flotation, it is common practice to employ insufficient frother addition in the flotation process, as a precaution to avoid the overfrothing problem, which often leads to significant loss of flotation recovery.

It will be clearly understood that, if a prior art publication is referred to herein, this reference does not constitute an admission that the publication forms part of the common general knowledge in the art in Australia or in any other country.

### SUMMARY OF INVENTION

The present invention is directed to a method for stabilising a froth or a foam which may at least partially overcome at least one of the abovementioned disadvantages or provide the consumer with a useful or commercial choice. The present invention is also directed towards a froth flotation method.

With the foregoing in view, the present invention in one form, resides broadly in a method for stabilising a froth or a foam comprising subjecting the froth or foam to vibrations or sound waves having a frequency of less than 20 kHz.

In one embodiment, the froth or foam is subject to vibrations or sound waves having a frequency of less than 15 kHz, or less than 10 kHz, or less than 9 Khz, or less than 8 kHz, or less than 7 kHz, or less than 6 kHz, or less than 5 kHz, or less than 4 kHz, or less than 3 kHz, or less than 2 kHz, or less than 1 kHz. In one embodiment, the froth or foam is subject to vibrations or sound waves having frequency of from 200 Hz to 1,000 Hz, or from 250 Hz to 800 Hz, or from 300 Hz to 700 Hz, or from 300 Hz to 500 Hz, or from 300 to 450 Hz, or from 300 to 400 Hz.

In one embodiment, the froth or foam is subjected to vibrations or sound waves by applying vibrations or sound waves to the froth or foam. The vibrations or sound waves may be applied by a vibration generator or by a speaker.

In one embodiment, the vibrations or sound waves that are applied to the froth or foam is applied at an amplitude of at least 80 dB, such as from 80 dB to 125 dB, or from 90 dB to 120 dB, or from 90 dB to 110 dB, or from 90 dB to 105 dB, or from 80 to 95 dB, or from 85 to 90 dB. It will be appreciated that a minimum amplitude of the vibrations of sound waves that is effective in stabilising the froth or foam at the selected frequency should be used in order to minimise occupational health and safety risks to operating personnel.

In one embodiment, the froth or foam is stabilised by applying sound waves to the froth or foam. This may be achieved by directing sound waves from one or more speakers to the froth or foam. In one embodiment, at least one speaker is positioned above the froth or foam. In another embodiment, at least one speaker is positioned within the froth or foam or within a liquid located below a liquid/froth interface. In one embodiment, at least one speaker is mounted in a wall of the vessel in which the froth or foam is generated. In this embodiment, the speaker or speakers may be positioned in a wall of the vessel at a location below the liquid/froth interface in the vessel.

In embodiments where the at least one speaker is located above the froth or foam, the at least one speaker is preferably located in close proximity to the froth foam or sound from the at least one speaker is directed to the froth or foam.

In one embodiment, at least one speaker is located in the liquid and below the liquid/froth interface. In this embodiment, the at least one speaker may face upwardly towards the liquid/froth interface. In this embodiment, the at least one speaker may apply sound waves at a level of from 85 to 90 dB. In one embodiment, the at least one speaker is placed just below the liquid/froth interface, for example, up to 10 cm below the liquid/froth interface, or up to 7.5 cm below the liquid/froth interface, or up to 5 cm below the liquid/froth interface or up to 2.5 cm below the liquid/froth interface, or about 1 to 1.5 cm below the liquid/froth interface. In other embodiments, the at least one speaker may be placed well below the liquid/froth interface. It has been found that placing the at least one speaker in the liquid and below the liquid/froth interface can result in good froth stabilisation at lower levels of sound than if the at least one speaker is placed in the air above the froth.

In one embodiment, the froth or foam has a bubble size of from 0.1 mm to 5 cm, or from 0.5 mm to 4 cm, or from 0.5 mm to 3 cm, or from 0.5 mm to 2 cm or from 5 mm to 2 cm. Throughout this specification the term “bubble size” is used to refer to an average bubble size. Average bubble size may be determined using the Sauter mean diameter, which is commonly used to describe bubbles in a froth flotation system.

In a second aspect, the present invention provides a froth flotation process comprising forming bubbles in a liquid containing particulate mineral material whereby particles containing valuable mineral material stick to the bubbles and rise upwardly through the liquid with the bubbles whilst non-valuable mineral particles sink in the liquid, and a froth of bubbles is formed above a liquid/froth interface, wherein the froth is stabilised by subjecting the froth to vibrations or sound waves having a frequency of less than 20 kHz.

In one embodiment, the froth is subject to vibrations or sound waves having a frequency of less than 15 kHz, or less than 10 kHz, or less than 9 Khz, or less than 8 kHz, or less than 7 kHz, or less than 6 kHz, or less than 5 kHz, or less than 4 kHz, or less than 3 kHz, or less than 2 kHz, or less than 1 kHz. In one embodiment, the froth is subject to vibrations or sound waves having frequency of from 200 Hz to 1,000 Hz, or from 250 Hz to 800 Hz, or from 300 Hz to 700 Hz, or from 300 Hz to 500 Hz, or from 300 to 450 Hz, or from 300 to 400 Hz.

In one embodiment, the froth is subjected to vibrations or sound waves by applying vibrations or sound waves to the froth or foam. The vibrations or sound waves may be applied by a vibration generator or by a speaker.

In one embodiment, the vibrations or sound waves that are applied to the froth is applied at an amplitude of at least 80 dB, such as from 80 dB to 120 dB, or from 90 dB to 110 dB, or from 90 dB to 105 dB, or from 80 to 95 dB, or from 85 to 90 dB. It will be appreciated that a minimum amplitude of the vibrations of sound waves that is effective in stabilising the froth at the selected frequency is desirably be used in order to minimise occupational health and safety risks to operating personnel.

In one embodiment, the froth is present at the top of a flotation vessel and the froth is stabilised by applying sound waves to the froth. This may be achieved by directing sound waves from one or more speakers to the froth. In one embodiment, at least one speaker is positioned above the froth or foam in the flotation vessel. In another embodiment, at least one speaker is positioned within the froth or within a liquid located below a liquid/froth interface. In one embodiment, at least one speaker is mounted in a wall of the flotation vessel in which the froth is generated or in which the froth is present. In this embodiment, the speaker or speakers may be positioned in a wall of the flotation vessel at a location below the liquid/froth interface in the vessel.

In embodiments where the at least one speaker is located above the froth, the at least one speaker is preferably located in close proximity to the froth or sound from the at least one speaker is directed to the froth or foam.

In one embodiment, at least one speaker is located in the liquid and below the liquid/froth interface. In this embodiment, the at least one speaker may face upwardly towards the liquid/froth interface. In this embodiment, the at least one speaker may apply sound waves at a level of from 85 to 90 dB. In one embodiment, the at least one speaker is placed just below the liquid/froth interface, for example, up to 10 cm below the liquid/froth interface, or up to 7.5 cm below the liquid/froth interface, or up to 5 cm below the liquid/froth interface or up to 2.5 cm below the liquid/froth interface, or about 1 to 1.5 cm below the liquid/froth interface. In other embodiments, the at least one speaker may be placed well below the liquid/froth interface. It has been found that placing the at least one speaker in the liquid and below the liquid/froth interface can result in good froth stabilisation at lower levels of sound than if the at least one speaker is placed in the air above the froth.

In embodiments of the first aspect and the second aspect of the present invention, the sound waves that are applied to the froth or foam are additional to any ambient noise that may be present in the vicinity of the froth or foam. In one embodiment, sound waves having a predetermined frequency or a predetermined frequency range and a predetermined amplitude or predetermined amplitude range are applied to the froth or foam.

The method of the second aspect of the present invention will typically comprise a step of adding a frother to the liquid. In some embodiments, a collector is also added. In some embodiments, the frother may also act as a collector. The collector assists in the particles containing the valuable mineral material sticking to the bubbles. This is well known to persons skilled in the art and need not be described further.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Various embodiments of the invention will be described with reference to the following drawings, in which:

FIG. 1 shows a schematic diagram of an experiment setup for measuring the dynamic stability of froth with acoustic vibration;

FIG. 2 is a graph that shows the equilibrium froth height with varying sound frequency;

FIG. 3 shows a schematic diagram of an experiment setup for flotation of coal or quartz in a flotation column;

FIG. 4 shows a graph of cumulative flotation recovery of quartz versus flotation time;

FIG. 5 shows a graph of cumulative flotation recovery of coal versus flotation time;

FIG. 6 shows a schematic diagram of an experiment setup for flotation of coal or quartz in a mechanical cell;

FIG. 7 shows a graph of cumulative flotation recovery of coal versus flotation time for flotation tests conducted using a mechanical flotation cell;

FIG. 8 shows a graph of cumulative flotation recovery of silica versus flotation time in the presence and absence of sound;

FIG. 9 shows a schematic diagram of a mechanical flotation cell having an underwater speaker, as used in an experiment conducted in accordance with an embodiment of the present invention;

FIG. 10 is a graph showing cumulative recovery of quartz particles versus time for experiments conducted in the apparatus shown schematically in FIG. 9 compared with a similar test conducted without sound. The graph of FIG. 10 was generated using experimental data fitted to a classical model;

FIG. 11 is a graph showing cumulative recovery of quartz particles versus time for experiments conducted in the apparatus shown schematically in FIG. 9 compared with a similar test conducted without sound. The graph of FIG. 11 was generated using experimental data fitted to a rectangular model;

FIG. 12 is a graph showing cumulative recovery of quartz particles versus time for experiments conducted in the apparatus shown schematically in FIG. 9 compared with a similar test conducted without sound. The graph of FIG. 12 was generated using experimental data fitted to a Gamma model;

FIGS. 13 and 14 are graphs showing changes in maximum foam height caused by applying acoustic sound at different air flow rates: FIGS. 13—3 L/min and FIGS. 14—6 L/min. The error bars represent one standard deviation obtained from two independent runs.

### DESCRIPTION OF EMBODIMENTS

It will be appreciated that the drawings and the examples have been provided for the purposes of illustrating preferred embodiments of the present invention. Therefore, the skilled person will understand that the present invention should not be considered to be limited solely to the features as shown in the drawings or the examples.

The following embodiments largely relate to froth stabilisation in froth flotation processes. However, it will be appreciated that the method of the present invention may also be used to stabilise foams and bubbles.

Some embodiments of the present invention are based upon improving froth flotation performance by increasing the stability of froth within the flotation cell. The present invention is based upon some fundamental studies recently conducted by the present inventors. In particular, the present inventors have conducted fundamental studies on froth stability and bubble coalescence in froth flotation and the study suggested that it would be possible to improve froth stability by introducing a dynamic effect, such as by acoustic vibrations generated using a speaker, into the froth. The inventors observed that the stability of thin liquid films confined between bubbles was high at a specific frequency of sound waves, in stark contrast to the lifetime and stability at other frequencies tested. As a result, the present inventors have postulated that vibrations, such as sound waves, can be used to stabilise bubbles, foams and froths. Flotation tests conducted by the inventors for a coal sample and a quartz sample found that by applying acoustic vibrations on flotation froth at a specific frequency, froth stability was significantly increased. This resulted in an increase in flotation recovery of five percentage points more.

The inventors expect that embodiments of the present invention will be applicable for improving coal flotation and mineral flotation different types of flotation apparatus. Further, the dynamic stabilisation may be achieved using different methods, such as use of a sound speaker, use of a push-pull type solenoid, use of an oscillating piston, or use of other vibration generators.

It is expected that embodiments of the present invention can be applied to any existing flotation cells. Successful deployment of embodiments of the present invention could lead to improved flotation performance, reduced reagent dosage and improved process smoothness.

### Example 1—Froth Stabilisation

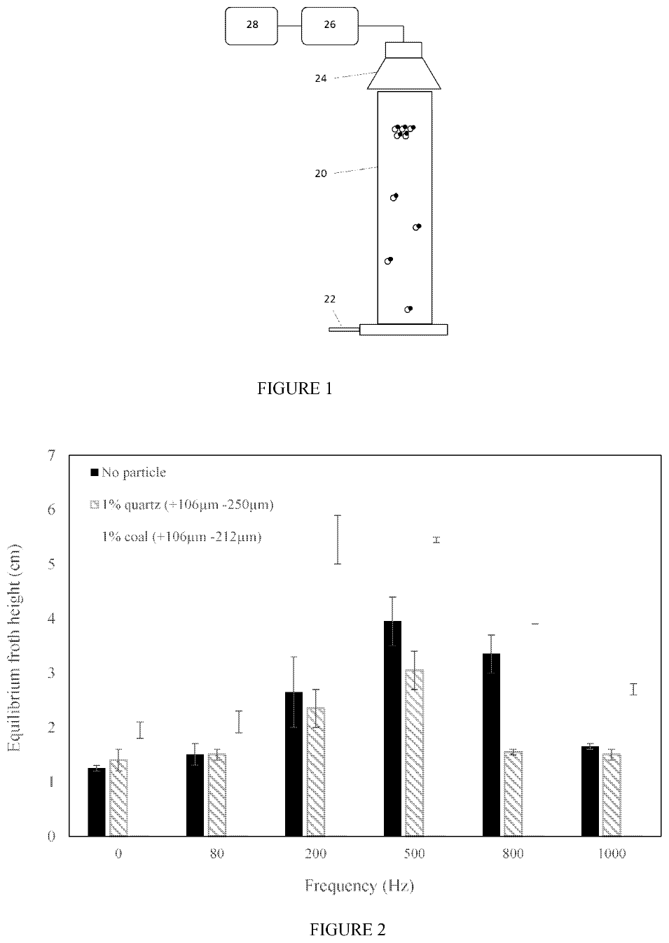

FIG. 1 shows a schematic diagram of an experiment setup for measuring the dynamic stability of froth with acoustic vibration. A column 20 with 5 cm inner diameter and 78 cm height, a gas supply unit that supplies gas through gas inlet pipe 22, and a stereo system comprising a speaker 24, an amplifier 26 and a computer 28 that controls the amplifier, was used to study the dynamic stability of froth with or without acoustic vibration. The froth was generated from 15 ppm MIBC solution in the presence of 0.008 M NaCl at a superficial gas velocity of 1.5 cm/s. The loudspeaker was placed above the column at a distance of 0.5 cm to send the sound waves to the froth (see FIG. 1). Upon the start of the test, the gas supply was turned on. After the froth reached its equilibrium height, the loudspeaker was turned on and the change in equilibrium height was recorded. Quartz particles (106 μm-250 μm) and coal particles (106 μm-212 μm) were tested separately. The solid concentration was 1%.

FIG. 2 shows the results of the dynamic stability of froth represented by the equilibrium froth height. The froth stability increased with increasing sound frequency, reaching a peak at a frequency (i.e., 500 Hz) before decreasing at higher frequencies. Without sound (indicated at the point of frequency of 0 in the figure), the equilibrium heights of foam, froth with quartz and froth with coal were 1.25 cm, 2.3 cm and 1.95 cm, respectively; with sound at 500 Hz, the equilibrium heights of foam, froth with quartz and froth with coal reached 1.95 cm, 3.05 cm and 5.45 cm, respectively. The bubble size at the bottom of the froth was estimated to be around 0.5 cm.

### Example 2—Froth Flotation Experiments

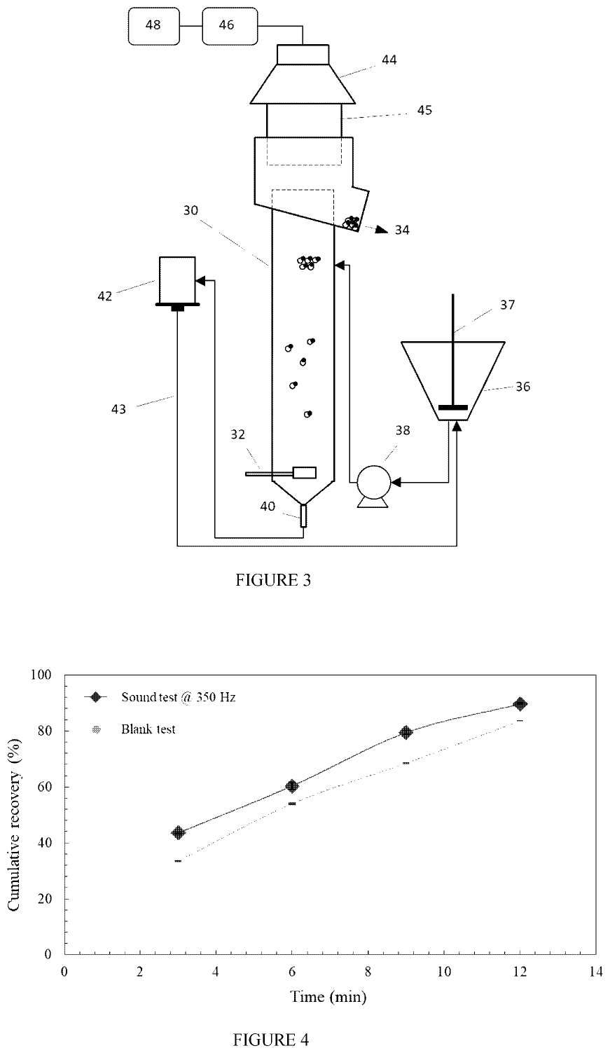

FIG. 3 shows a schematic diagram of the apparatus used in the froth flotation experiments. A flotation column with 5 cm inner diameter and 1.4 m height and a stereo system (Fx-10, Visaton, 70-22000 Hz (loudspeaker) and a stereo amplifier) was used (see FIG. 3). In FIG. 3, the column 30 receives air from an air inlet pipe 32. A slurry is added to the column 30. Column 30 has a froth overflow outlet 34. The froth that leaves the column through froth overflow 34 may be collected for analysis or sent to recycle collection vessel 36. The recycle vessel 36 has an agitator 37 to stir the slurry. A pump 38 recycles slurry from the recycle collection vessel 36 back to the column 30. A tailings slurry is removed at outlet 40 and is sent to froth level controller 42 and thereafter via line 43 to the recycle collection vessel 36. A speaker 44 is located 10 cm above the top of the column 30. The speaker 44 applies sound waves through a cylindrical plastic tube (sound concentrating device) 45 to the froth in the column 30. An amplifier 46 that is controlled by a computer 48 controls the frequency and amplitude of the sound waves produced by the speaker 44.

Batch mode column flotation of quartz and coal were separately conducted. In quartz flotation, the particle size was below 98 μm and the solid concentration was 5%. EHPA at 1000 g/t was used. The flow rate of the feed slurry was 1.2 L/min and the gas superficial velocity was 1 cm/s. In coal flotation, the particle size was below 500 μm and the solids concentration was 5%. MIBC at 15 ppm and 20 ppm were tested with diesel. The flow rate of the feed slurry was 1.2 L/min and the gas superficial velocity was 1.7 cm/s.

FIG. 4 shows the results of the batch mode flotation of quartz. The application of sound wave at 350 Hz significantly increased the recovery of the quartz flotation. In the blank test without sound wave, the cumulative recovery at 12 min was 83.6%. In the flotation test with sound, the cumulative recovery at 12 min was increased to 89.73%. The increase in quartz recovery was 6.1 percentage points.

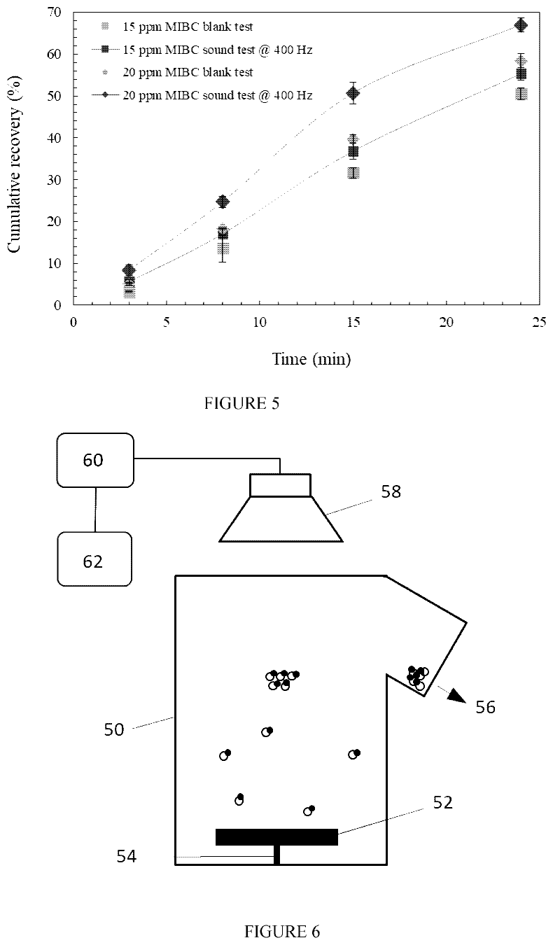

FIG. 5 shows the results of the batch mode column flotation of coal. At a given MIBC dosage and a given flotation time, the cumulative recovery (yield) of the coal flotation with sound wave was always higher than that without sound wave. When the flotation time was 4 min, use of sound wave improved the yield by 8.5 percentage points for the coal flotation with 20 ppm MIBC and 4.9 percentage points for the coal flotation with 15 ppm MIBC. Note that the outcome of the flotation test at 15 ppm MIBC with sound wave was very close to that of 20 ppm MIBC without sound wave, suggesting that one can reduce frother addition while keeping the flotation recovery the same.

FIG. 6 shows a schematic diagram of apparatus used in an experiment using mechanical flotation. In FIG. 6, a flotation vessel 50 has an agitator 52 and an air inlet 54. As is common in mechanical flotation, air is passed into the vessel 50 through air inlet 54 and agitator 52 breaks up the air into small bubbles. The vessel 50 has a froth overflow 56. Froth or concentrate is removed from overflow 56. A loudspeaker 58 was positioned 8 cm above the lip where froth is discharged, or approximately 5 cm above the top of the froth, with the depth of the overflowing froth over the lip being approximately 3 cm. As the loudspeaker was positioned closer to the froth than in the column tests shown in FIG. 1, it was not necessary to use the sound concentrator between the loudspeaker and the froth. The loudspeaker 58 was controlled by an amplifier 60 and a computer 62.

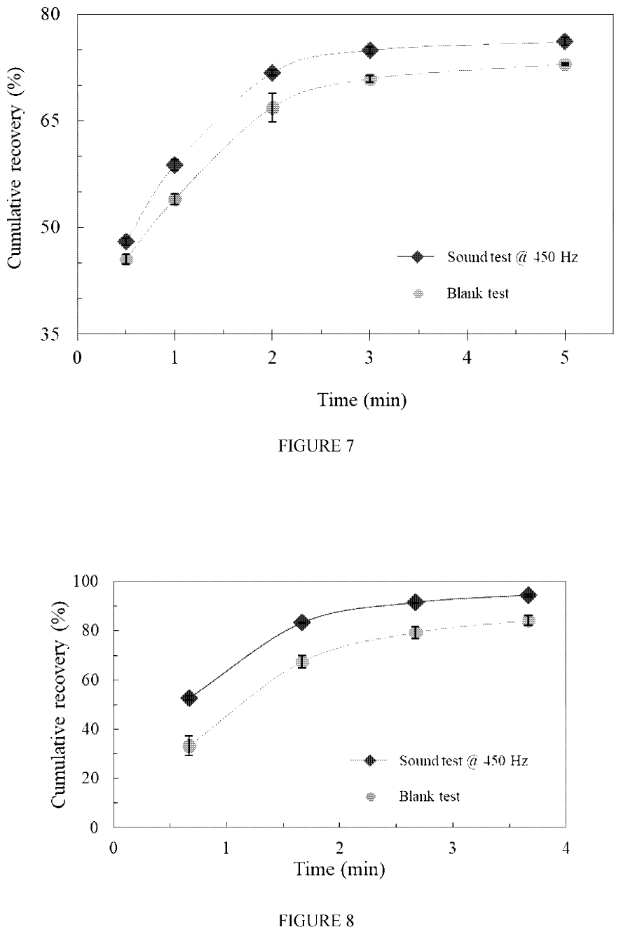

FIG. 7 shows the results of the mechanical flotation of coal. At a given flotation time, the cumulative recovery (yield) of the coal flotation with sound wave was always higher than that without sound wave. When the flotation time was 5 min, use of sound wave improved the yield by 3.2 percentage points for the coal flotation.

Table 1 summarises the coal flotation results obtained using the column cell and the mechanical cell with and without sound. The increase in combustible recovery caused a decrease in product grade (an increase in product ash content). However, the decrease in grade was far outweighed by the substantial increase in recovery.

TABLE 1
Comparison of coal flotation results with and without sound.

| | Blank | | With sound | |
|---|---|---|---|---|
| | Ash | Comb. Rec. | Ash | Comb. Rec. |
| Flotation cell type | (% wt) | (%) | (% wt) | (%) |
| Column | 8.5 ^{a} | 65.8 ^{a} | 8.9 ^{a} | 73.8 ^{a} |
| | 7.7 ^{b} | 56.2 ^{b} | 8.2 ^{b} | 61.3 ^{b} |
| Mechanical | 6.7 | 79.9 | 7.3 | 83.0 |

^{a} 20 ppm frother
^{b} 15 ppm frother
Conditions for column flotation tests: sound frequency = 350 Hz, sound amplitude = 125 dB, flotation time = 4 min, frother = 20 or 15 ppm frother (MIBC), collector = 240 g/t diesel, aeration rate = 1.7 cm/s, coal particle size <500 μm.
Conditions for mechanical flotation tests: sound frequency = 450 Hz, sound pressure amplitude = 110 dB, flotation time = 5 min, frother = 20 ppm MIBC, collector = 150 g/t diesel, aeration rate = 0.41 cm/s, coal particle size <500 μm.

FIG. 8 shows the results of the mechanical flotation of quartz. At a given flotation time, the cumulative recovery of the quartz flotation with sound wave was always higher than that without sound wave. When the flotation time was 3.7 min, use of sound wave improved the yield by 10.3 percentage points for the quartz flotation.

Table 2 summarises the quartz flotation results obtained using the column cell and the mechanical cell with and without sound.

TABLE 2
Comparison of quartz flotation results with and without sound.

Rec. (%)

| Flotation cell type | Blank | With sound |
|---|---|---|
| Column | 83.6 | 89.7 |
| Mechanical | 84.3 | 94.6 |

Conditions for column flotation: frequency = 350 Hz, amplitude = 125 dB, flotation time = 12 min, collector dosage = 1000 g/t 3-(2-Ethylhexyloxy)propylamine (EHPA), aeration rate = 1.0 cm/s, quartz particle size <98 μm.
Conditions for mechanical flotation: frequency = 450 Hz, amplitude = 110 dB, flotation time = 3.7 min, collector dosage = 150 g/t EHPA, aeration rate = 0.35 cm/s, quartz's 80% passing size = 90 μm.

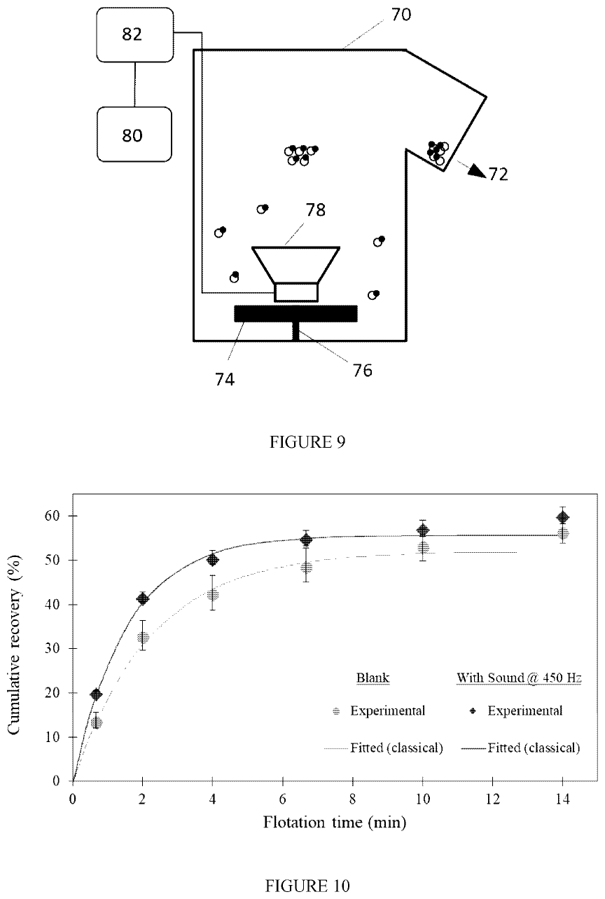

FIG. 9 shows a schematic diagram of a mechanical flotation cell with an underwater speaker that was used in further experiments. In the experimental setup shown in FIG. 9, a flotation vessel 70 has an overflow 72 through which concentrate (froth plus adhering particles) can exit the vessel. An agitator 74 having an air supply line 76 is located towards the bottom of the vessel 70. An immersible loudspeaker 78 is located below the froth/liquid interface, with the speaker facing upwardly so that the cone of the speaker faces upwardly. A signal generator 80 generates a sound signal that is sent to stereo amplifier 82. The stereo amplifier 82 drives the speaker 78 so that the speaker transmits sound waves into the liquid.

Quartz flotation tests were carried out using the experimental setup shown in FIG. 9. The speaker was placed in the slurry. The experimental conditions were as follows:
Sound frequency was 450 Hz;
The 80% passing size of the quartz particles was 43.3 μm;
150 g/ton ether amine was used as collector;
Solids concentration of the slurry loaded to the flotation cell was 5% by weight;
Rotation speed=700 rpm,
Air flow rate=2.5 L/min
3 independent tests each for blank and with sound (450 Hz)

The following operating conditions were used in these experiments:

| | |
|---|---|
| Feed conc. (% solid) | 5 |
| Feed mass (kg) | 0.055 |
| Water (L, kg) | 1.045 |
| Total mass (kg) | 1.1 |
| Rotation (rpm) | 700 |
| Gas rate, (L/min) | 2.5 |
| Process time (min) | 14 |
| Collector (g/ton) | 150 |
| Frother (ppm) | 0 |

The apparent flotation rate constant was obtained by fitting the experimental cumulative recovery data to three common kinetic models, namely the classical first-order kinetic model (Garcia-Zúñiga, 1935), Rectangular model (Huber-Panu et al., 1976; Klimpel, 1980) and Gamma model (Imaizumi & Inoue, 1963). These models have 2, 2 and 3 fitting parameters, respectively. Their expressions and mean rate constants, kₘₑₐₙ are given in Table 3. The fittings were done by non-linear regression analysis with the method of least squares. The kₘₑₐₙ values were used to compare the flotation kinetics at different experimental conditions.

TABLE 3
The expressions of three kinetic models of interest and
their mean rate constants, kₘₑₐₙ.

| # | Model | R(t) | kₘₑₐₙ |
|---|---|---|---|
| 1 | Classical First Order | R∞[1 − exp(−kt)] | k |
| 2 | Rectangular | ${R}_{∞} [ 1 - \frac{1 - exp ( - {k}_{max} t )}{{k}_{max} t} ]$ | kₘₐₓ/2 |
| 3 | Gamma | ${R}_{∞} [ 1 - \frac{1}{{( 1 + {k}_{0} t )}^{a}} ]$ | k₀ · a |

*R∞ is the maximum recovery, t is the flotation time, k is the single distributed rate constant in Model 1, kₘₐₓ is the maximum rate constant in Model 2, k₀ represents the distribution of the rate function in Model 3 and a is the Gamma shape parameter.
**The kₘₑₐₙ of each model is adapted from Vinnett et al. (2018).

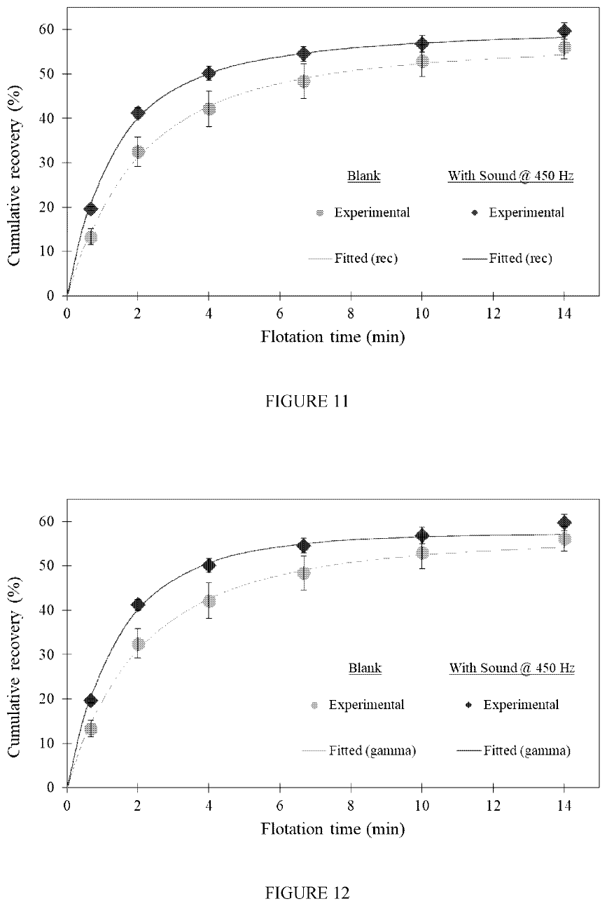

FIGS. 10, 11 and 12 show the results of these experiments, with the results of FIG. 10 being modelled using a classical model, FIG. 11 using a rectangular model and FIG. 12 using a Gamma model.

At a given flotation time, the cumulative recovery of the quartz flotation with sound wave was higher than that without sound wave. For example, when the flotation time was 2 min, use of sound wave improved the yield by 8.7 percentage points for the quartz flotation; when the flotation time was 4 min, use of sound wave improved the yield by 8.0 percentage points for the quartz flotation.

The cumulative recovery-versus-time data were fitted to three different models (see Table 3). The relative increases in flotation rate kₘₑₐₙ caused by applying the sound were 44%-53%, depending on which model was used to fit the experimental data; For each model used, there was no statistically significant difference in the fitted final recovery Rₘₐₓ between the blank test and the sound test; Each set of experimental data was well fitted to the models, with R-square value being greater than 0.99.

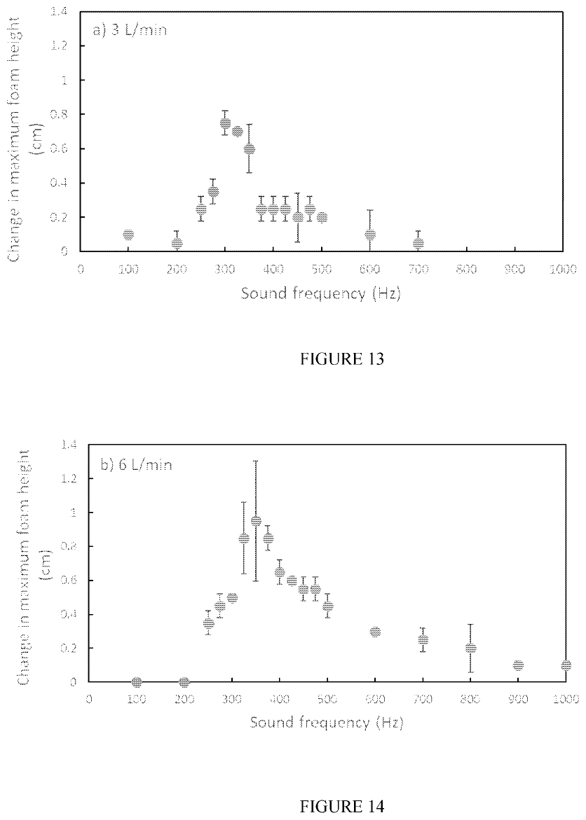

In order to investigate froth stability, a rectangular column was mounted on the mechanical flotation cell. 2.7 L of 1×10⁻⁴ M sodium dodecyl sulphate solution was loaded into the flotation cell. The underwater speaker's diaphragm was 1.5 cm below the pulp/froth interface, the rotation speed was 500 r/min, air flow rate was 3 L/min or 6 L/min. FIGS. 13 and 14 show the change in the maximum foam height (at steady state) for the two different air flow rates caused by switching on the speaker. The results suggested that the preferred frequency of sound for maximising the foam stability was 300-400 Hz.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A method for stabilising a froth or a foam comprising subjecting the froth or foam to vibrations or sound waves having a frequency of less than 20 kHz.

2. A method as claimed in claim 1 wherein the froth or foam is subject to vibrations or sound waves having a frequency of less than 15 kHz, or less than 10 kHz, or less than 9 Khz, or less than 8 kHz, or less than 7 kHz, or less than 6 kHz, or less than 5 kHz, or less than 4 kHz, or less than 3 kHz, or less than 2 kHz, or less than 1 kHz.

3. (canceled)

4. A method as claimed in claim 1 wherein the froth or foam is subject to sound waves having a frequency of from 300 Hz to 500 Hz, or from 300 to 450 Hz, or from 300 to 400 Hz.

5. A method as claimed in claim 1 wherein the vibrations or sound waves are applied by a vibration generator or by a speaker.

6. A method as claimed in claim 1 wherein the vibrations or sound waves that are applied to the froth or foam is applied at an amplitude of at least 80 dB, or from 80 dB to 125 dB, or from 90 dB to 120 dB, or from 90 dB to 110 dB, or from 90 dB to 105 dB, or from 80 to 95 dB, or from 85 to 90 dB.

7. A method as claimed in claim 1 wherein the froth or foam is stabilised by applying sound waves to the froth or foam by directing sound waves from one or more speakers to the froth or foam.

8. A method as claimed in claim 7 wherein at least one speaker is positioned above the froth or foam.

9. (canceled)

10. A method as claimed in claim 7 wherein at least one speaker is positioned within the froth or foam or within a liquid located below a liquid/froth interface.

11. A method as claimed in claim 7 wherein the at least one speaker is located in the liquid and below the liquid/froth interface and the at least one speaker faces upwardly towards the liquid/froth interface and the at least one speaker applies sound waves at a level of from 85 to 90 dB.

12. A method as claimed in claim 11 wherein the at least one speaker is placed just below the liquid/froth interface or the at least one speaker is placed up to 10 cm below the liquid/froth interface, or up to 7.5 cm below the liquid/froth interface, or up to 5 cm below the liquid/froth interface or up to 2.5 cm below the liquid/froth interface, or about 1 to 1.5 cm below the liquid/froth interface.

13. A froth flotation method comprising forming bubbles in a liquid containing particulate mineral material whereby particles containing valuable mineral material stick to the bubbles and rise upwardly through the liquid with the bubbles whilst non-valuable mineral particles sink in the liquid, and a froth of bubbles is formed above a liquid/froth interface, wherein the froth is stabilised by subjecting the froth to vibrations or sound waves having a frequency of less than 20 kHz.

14. A method as claimed in claim 13 wherein the froth or foam is subject to vibrations or sound waves having a frequency of less than 15 kHz, or less than 10 kHz, or less than 9 Khz, or less than 8 kHz, or less than 7 kHz, or less than 6 kHz, or less than 5 kHz, or less than 4 kHz, or less than 3 kHz, or less than 2 kHz, or less than 1 kHz.

15. (canceled)

16. A method as claimed in claim 13 wherein the froth or foam is subject to sound waves having a frequency of from 300 Hz to 500 Hz, or from 300 to 450 Hz, or from 300 to 400 Hz.

17. A method as claimed in claim 13 wherein the vibrations or sound waves that are applied to the froth or foam is applied at an amplitude of at least 80 dB, or from 80 dB to 125 dB, or from 90 dB to 120 dB, or from 90 dB to 110 dB, or from 90 dB to 105 dB, or from 80 to 95 dB, or from 85 to 90 dB.

18. A method as claimed in claim 13 wherein the froth or foam is stabilised by applying sound waves to the froth or foam by directing sound waves from one or more speakers to the froth or foam.

19. A method as claimed in claim 18 wherein at least one speaker is positioned above the froth or foam.

20. A method as claimed in claim 18 wherein at least one speaker is positioned within the froth or foam or within a liquid located below a liquid/froth interface.

21. (canceled)

22. A method as claimed in claim 13 wherein the froth is present at the top of a flotation vessel and the froth is stabilised by applying sound waves to the froth by directing sound waves from one or more speakers to the froth and at least one speaker is positioned above the froth or foam in the flotation vessel, or at least one speaker is positioned within the froth or within a liquid located below a liquid/froth interface.

23. A method as claimed in claim 18 wherein at least one speaker is located in the liquid and below the liquid/froth interface and the at least one speaker faces upwardly towards the liquid/froth interface, the at least one speaker applying sound waves at a level of from 80 to 95 dB or from 85 to 90 dB.

24. A method as claimed in claim 22 wherein the at least one speaker is placed just below the liquid/froth interface, or up to 10 cm below the liquid/froth interface, or up to 7.5 cm below the liquid/froth interface, or up to 5 cm below the liquid/froth interface or up to 2.5 cm below the liquid/froth interface, or about 1 to 1.5 cm below the liquid/froth interface.

25. (canceled)
